(19) United States
(12) Patent Application Publication
(10) Pub. No.: US 2004/0035630 A1
(43) Pub. Date: Feb. 26, 2004

(54) Apparatus for detecting an occupant of a two-wheeled motor vehicle

(76) Inventors: Thomas Lich, Schwaikheim (DE); Frank Mack, Stuttgart (DE)

Correspondence Address: KENYON & KENYON, ONE BROADWAY, NEW YORK, NY, 10004, US

(21) Appl. No.: 10/422,166

(22) Filed: Apr. 23, 2003

(30) Foreign Application Priority Data
May 25, 2002 (DE) 10223366.7

(51) Int. Cl. B60D 1/28; G05D 1/00

(52) U.S. Cl. 180/271; 701/45

(57) ABSTRACT

An apparatus for detecting at least one occupant of a two-wheeled motor vehicle, the two-wheeled motor vehicle being equipped with at least one detection device that detects the at least one occupant, vehicle components being then activatable as a function of a signal of the detection device. Restraint devices, in particular, are indicated as such vehicle components. The detection device makes possible determination of the mass and the number of occupants, and classification of the occupants in terms of mass. Pressure-sensitive sensors, switches, load cells, or foil strain gauges can be used as detection devices.

### BACKGROUND INFORMATION

European Patent No. 925 730 describes a protection system for a motorcycle rider. This protective system is activated as soon as the motorcycle rider becomes separated from the motorcycle.

### SUMMARY OF THE INVENTION

The apparatus according to the present invention for detecting an occupant of a two-wheeled motor vehicle has, in contrast thereto, the advantage that detection means are provided, the detection means then delivering a signal in order to activate vehicle components such as retention systems and other rider-assisting systems such as ABS (antilock braking system). This applies to the rider and also to a passenger who may possibly be present. Overall, therefore, the apparatus according to the present invention enhances safety and comfort for the occupants.

It is particularly advantageous that the signal from the detection means is used for the activation of restraint means. For motorcycle riders in particular, protection by way of restraint means in the event of an accident is very important, since motorcycle riders are exposed to greater risks than automobile drivers because of the absence of bodywork.

In particular, the detection means are advantageously configured to measure the mass of the at least one occupant, evaluation means being present which use mass for classification of the occupant. The classification is of interest in particular for the appropriate use of restraint means, and on the other hand also for the use of other rider-assisting systems such as ABS, since the antilock braking system can then be used as a function of the mass of the rider to offer optimum comfort and protection. It is additionally advantageous that as the detection means, at least one sensor is installed in such a way that the sensor ascertains a seat position of the at least one occupant and the number of occupants. This information, too, is important so that restraint means and other rider-assisting systems can be optimally utilized. Provision can also be made, in this context, for the use of simple mechanical switches or other pressure-dependent switches which simply indicate whether, and at what location, a person is present on a seat of a motorcycle.

Alternatively, it is possible for the sensor to be configured in such a way that it delivers a pressure-dependent signal. The mass or weight of the relevant person or persons can then easily be derived therefrom. A pressure-sensitive mat that is installed in the seat can be used as one such pressure-sensitive sensor. Load cells or sensors that are positioned in the region of the swingarm or the rear wheel to sense the mass can also be used here. Foil strain gauges are particularly suitable for this purpose.

### BRIEF DESCRIPTION OF THE DRAWINGS

FIG. 1 schematically depicts a motorcycle having the apparatus according to the present invention.

FIG. 2 shows sensors that react sensitively to pressure and are installed in the seat.

### DETAILED DESCRIPTION

Future generations of motorcycles will be equipped with a motorcycle restraint system airbag. The intention here is to ensure better protection for the motorcycle rider using an airbag that is housed on the tank. This requires, however, classification and detection of the rider and of a possible passenger or additional luggage.

According to the present invention, therefore, detection means are provided on the motorcycle which make possible identification of an occupant. It is also possible to identify the number of occupants. In particular, the seat position and mass are also to be determined in order to supply rider-assisting systems, for example the ABS system, with information that will guarantee optimum comfort and protection for the occupants. The restraint systems in particular are intended to profit from the signal of the detection means, since the restraint means are then utilized as a function of the occupants identified. The result, in particular, is to prevent unnecessary or hazardous utilization of restraint means.

A variety of sensing systems are possible as detection means. Firstly, simple sensors that indicate “occupied” or “unoccupied” are provided. This can be achieved, for example, by using a pressure-sensitive sensor mat that is installed in the double seat. From this it is possible to ascertain where the rider is seated, and whether a passenger is also riding. For the simplest detection, a simple switch can likewise be incorporated into the double seat, although it supplies no pressure-dependent information. The pressure information can, however, be used to determine the mass of the rider and of the passenger. An alternative possibility is to sense the mass on the basis of load cells. Foil strain gauge sensors or other sensors can, for this purpose, be mounted in the region of the swingarm or rear wheel, making possible specific sensing of the mass. The information from these detection means, i.e. from the sensor suite, can be evaluated using a simple processor, and conveyed to the corresponding systems in the motorcycle. Triggering of a restraint means on the motorcycle or on a two-wheeled motor vehicle can be accomplished by way of collision sensors that are mounted on the motorcycle, or situationally using a ripcord that connects the occupant to the motorcycle and is interrupted in the event of a collision as the occupant is thrown off, thus triggering the restraint means. The crash sensor suite can, for example by way of a wireless connection, activate restraint means that the occupants wear using a vest.

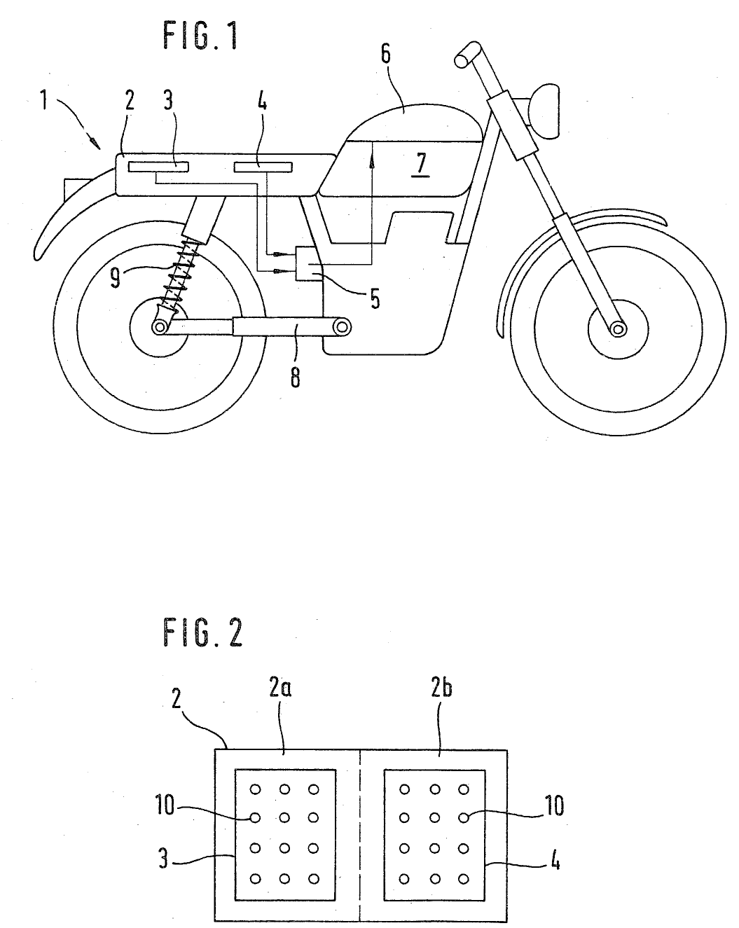

FIG. 1 schematically shows a motorcycle having the apparatus according to the present invention. Motorcycle 1 has a seat having a first sensor 3 and a second sensor 4, both of which are connected to a control unit 5. Control unit 5 processes the data from sensors 3 and 4. As a function of those data, control unit 5 activates an airbag 6 as restraint means on motorcycle tank 7. Control unit 5 is mounted in the vicinity of the engine and can also be connected to further vehicle components such as the ABS. The data from sensors 3 and 4, and their evaluation by control unit 5 which serves as evaluation means, are thereby also made available to other vehicle components. In addition to sensors 3 and 4 in seat 2, sensors can also be positioned in the region of the rear wheel, for example in spring element 9, or also in swingarm 8, in order to ascertain the mass of the occupants. Further sensor suite alternatives include infrared and ultra-low-power radar. High-frequency measurements are also possible here for occupant detection. Ultrasonic sensors are a further alternative.

FIG. 2 shows sensors 3 and 4 in a plan view, sensor 3 being located in seat region 2a on which a passenger would usually sit, and sensor 4 in seat region 2b on which the rider, in particular, would be present. Sensors 3 and 4 have a number of pressure-sensitive elements 10 which, for example, change their electrical resistance as a function of the weight pressure added by an occupant or luggage. Alternative pressure-sensitive variables are usable here. These seat mats 3 and 4, however, allow the seat position to be determined, and also allow conclusions as to the mass of the occupants. Simple separation and determination of the number of occupants is also made possible thereby. It is also possible in this context to use a single sensor as the seat mat, the sensor elements then offering a map of the pressure distribution and thereby also making possible identification and determination of the number of occupants.

The control unit or evaluation means for the sensor signals of sensors 3 and 4 can also be installed in seat 2. It is possible for the connection between sensors 3 and 4 and control unit 5 to be embodied wirelessly.

What is claimed is:

1. An apparatus for detecting at least one occupant of a two-wheeled motor vehicle, comprising:
means for detecting at least one occupant on the two-wheeled motor vehicle, the means for detecting providing a signal, at least one vehicle component being activatable as a function of the signal from the means for detecting.

2. The apparatus according to claim 1, wherein the at least one vehicle component includes at least one restraint device.

3. The apparatus according to claim 1, wherein the means for detecting measures a mass of the at least one occupant, and further comprising an evaluation device for classifying the occupant as a function of the mass.

4. The apparatus according to claim 1, wherein the means for detecting includes at least one sensor situated in a seat of the vehicle, the at least one sensor ascertaining a seat position of the at least one occupant, and a number of occupants.

5. The apparatus according to claim 4, wherein the at least one sensor includes a switch.

6. The apparatus according to claim 4, wherein the at least one sensor provides a pressure-dependent signal.

7. The apparatus according to claim 6, wherein the at least one sensor includes at least one pressure-sensitive mat situated in the seat.

8. The apparatus according to claim 6, wherein the at least one sensor includes at least one load cell.

9. The apparatus according to claim 1, further comprising at least one further sensor situated in a region of one of a swingarm and a rear wheel of the vehicle in order to sense a mass of the at least one occupant.

10. The apparatus according to claim 9, wherein the at least one further sensor includes a foil strain gauge.

11. The apparatus according to claim 1, wherein the means for detecting provides the signal to at least one further rider-assisting system.

12. The apparatus according to claim 11, wherein the at least one further rider-assisting system includes an antilock braking system.
